(19) United States
(12) Patent Application Publication
(10) Pub. No.: US 2009/0153296 A1
(43) Pub. Date: Jun. 18, 2009

(54) KEYLESS CONTROL SYSTEM

(76) Inventors: Francis M. LeGasse, Rochester Hills, MI (US); David Pearson, Sterling Heights, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/342,605

(22) Filed: Dec. 23, 2008

Related U.S. Application Data
(63) Continuation of application No. 11/689,785, filed on Mar. 22, 2007, now abandoned.
(60) Provisional application No. 60/785,042, filed on Mar. 23, 2006.

(51) Int. Cl. G05B 19/00

(52) U.S. Cl. 340/5.72

(57) ABSTRACT

A keyless control system for a motor vehicle or other structure operates to activate a device associated with the structure. The system includes a smart relay operating in conjunction with a control circuit, and a signal receiver which activates the relay upon receipt of an appropriate control signal. The signal may be an electromagnetic signal or an acoustic signal.

### CROSS-REFERENCE TO RELATED APPLICATIONS

This application claims priority to U.S. patent application Ser. No. 11/689,785, filed Mar. 22, 2007 entitled “Keyless Control System” and U.S. Provisional Patent Application Ser. No. 60/785,042 filed Mar. 23, 2006, entitled “Keyless Control System.”

### FIELD OF THE INVENTION

This invention relates generally to control systems. More specifically, the invention relates to radiofrequency activated keyless control systems. Specifically, the invention relates to a keyless control system for activating various functions associated with motor vehicles, building structures, and the like.

### BACKGROUND OF THE INVENTION

Keyless control systems are employed for activating various functions associated with motor vehicles, buildings and other such structures. For example, keyless entry systems unlock doors, activate lights, sound the horn, and carry out other functions in motor vehicles. Likewise, keyless entry systems can be employed to open doors, gates, and the like in buildings, parking lots and other such structures. The present invention will be described with general reference to keyless control systems for motor vehicles; however, it is to be understood that this invention may likewise be adapted for use in other structural environments.

The system of the present invention provides a keyless control system which can activate a number of different functions in a motor vehicle. These functions can include door locks, door openers, windows, the ignition system, the starter motor, the horn, the fuel pump and the like. It is a notable feature of the present invention that the control system is modular insofar as it relies upon the use of one or more “smart” relays which can be directly substituted for conventional relays in the motor vehicle. As such, the system of the present invention is readily retrofittable onto, and removable from, stock motor vehicles. In accord with another aspect of the present invention, various modes of operation of the controller are disclosed. These and other features and advantages of the present invention will be apparent from the discussion and description which follow.

### BRIEF DESCRIPTION OF THE INVENTION

Disclosed is a keyless control system for a motor vehicle or other structure. The system operates to activate a device associated with the structure, and includes a smart relay which is used in conjunction with a control circuit. The relay operates in conjunction with a receiver which is operable to receive a control signal such as an electromagnetic signal. Upon receipt of an appropriate control signal, the relay is activated. The control signal may be an electromagnetic signal such as a radiofrequency signal, a microwave signal or an optical signal. The control signal may also comprise an acoustic signal.

### BRIEF DESCRIPTION OF THE DRAWING

FIG. 1, the sole FIGURE, is a circuit diagram depicting one specific circuit which may be utilized to implement an embodiment of this invention as described in Appendix A.

### DETAILED DESCRIPTION OF THE PREFERRED EMBODIMENTS

The controller of the present invention employs a plurality of smart relays. Within the context of this disclosure, smart relays are understood to be relays which include a signal receiver associated therewith. The receiver, upon receipt of an appropriate control signal, causes the relay to be activated from an on state to an off state, or from an off state to an on state, and this relay controls one or more functions of the vehicle. For example, in one embodiment, the smart relay of the present invention is associated with electronic door locks of the motor vehicle. The relay, upon receipt of an appropriate control signal, then activates the electronic door locks so as to lock or unlock the motor vehicle. Likewise, the relays may be employed to enable the ignition switch of the vehicle, enable the starter and/or enable the fuel pump. In this manner, keyless control of the ignition system of the vehicle may be achieved. In such embodiments, the starter motor may then be activated either by a simple switch associated with the vehicle or by a key switch so as to allow the vehicle to be started upon receipt of an appropriate control signal. Also, by including appropriate relays, solenoids and the like, remote keyless starting may also be achieved. It will thus be seen that the system of the present invention can provide for true keyless operation of a motor vehicle while still providing for security.

The control signal may be an electromagnetic signal such as a radiofrequency, microwave, infrared or optical signal; alternatively, the control signal may be acoustic. The invention is described herein with reference to an embodiment where the control signal is a radiofrequency signal and the receiver is operable to receive that signal. However, it is to be understood that other types of signals and receivers may be likewise employed.

In one embodiment of the present invention, the smart relays are specifically configured so as to be direct replacements for stock relays in a motor vehicle. As such, the smart relays are mounted in conventional packages such as ISO and half ISO packages, and are configured to have standard ISO and half ISO footprints and connections. In such embodiments, the control system of the present invention may be readily installed into a motor vehicle by merely substituting the smart relays of the present invention for the conventional control relays found in the motor vehicle. This ease of installation allows for the simple, low cost retrofitting of the control system onto existing motor vehicles. Furthermore, the system of the present invention may be readily removed from the vehicle if necessary as a condition of the lease or sale of the vehicle.

The smart relays will typically include a receiver, such as a radiofrequency receiver which receives a control signal, as well as appropriate control circuitry which allows the receiver to recognize specific signals and activate the relay accordingly. The radiofrequency signal may be broadcast from conventional transmitters such as radiofrequency keypad or key fob transmitters, or from base station controllers. In accord with security technology, the signal may be appropriately encrypted, as for example by the use of rolling code security protocols (i.e., KEELOQ). In such instance, the smart relay, upon receipt of a valid control signal, activates a load, or enables activation of the load. The smart relays may be programmed prior to installation onto the vehicle, or they may be programmed after installation. Programming may be accomplished by an externally provided signal or by a signal generated by the vehicle itself.

In one specific installation, the control system can activate a starter relay so as to enable the operation of the starter. As noted above, this can provide true keyless start function for the vehicle. In such embodiments, the system can alternatively, or additionally, activate and deactivate the ignition circuitry, the fuel pump, and other such systems necessary for operation of the vehicle. Such activation and deactivation will provide further vehicular security, since a potential thief would have to activate a number of individual systems before being able to steal the vehicle. In further embodiments, the system may activate the horn of the vehicle so as to provide an alarm signal. It may likewise activate the power windows and door locks of the vehicle, and the system may also be operable in connection with an automated door opener.

In a further embodiment of the present invention, the smart relays are also operative to generate a radiofrequency signal indicative of the state of the relay, or the state of a load associated therewith. This signal could be broadcast to other smart relays in the system and/or to a remote location such as a base station or activating device such as a keypad or fob. This broadcast signal can provide information indicative of the condition of the vehicle. In other instances, this signal can function to control another relay and associated function in accord with the operation of a specific relay and function. For example, information broadcast from a smart relay can deactivate a key fob controller when a vehicle is in motion so as to prevent inadvertent activation of systems. In other instances, a starter relay can operate to activate the vehicle's fuel pump, running lights, or other systems. In yet another embodiment, the smart relays can be made responsive to a control signal from an airbag activation system so as to respond in the event of a crash. For example, the deployment of the airbags can cause the control system of the present invention to shut off the fuel pump, sound an alarm, unlock the vehicular doors, and lower the windows of the vehicle.

In another embodiment of the invention, smart relays of the present invention may be made responsive to a control signal emitted from a base station associated with a garage or other parking space. In such instance, the control signal will enable the operation of the starter, fuel pump, ignition or the like so as to allow motor vehicle operation upon appropriate activation by a key, or by a keyless system of the present invention. In the event that the vehicle is removed from proximity to the base transmitter, as for example by being towed away by thieves, the smart relay system will no longer receive the enable signal, and starting and running of the motor vehicle will not be possible. A system of this type may be further modified to operate in response to a base transmitter carried by an authorized driver of the vehicle. In such instance, operation of the vehicle will only be possible if a person having an appropriate transmitter is in proximity of the vehicle. Yet other modifications and variations in the operation of the system will be apparent to those of skill in the art.

In accord with another aspect of the present invention, the keyless entry system of the present invention, as well as other keyless entry systems, may be operated in particular modes having expanded functions. In one such embodiment, the system of the present invention may be programmed to employ various discrete entry codes which enable operation of the vehicle. Such codes can provide different modes of operation of the vehicle. For example, the entry system may be programmed to provide a valet code which, when entered, restricts the operation of the vehicle, as for example by allowing the vehicle to be driven only a preselected distance or at speeds not exceeding a preselected limit. In such instance, a valet or parking attendant could be given the appropriate code to activate the vehicle, but would be limited to operation under the restricted conditions. The system could be configured so that a code may be entered when the vehicle is running so as to put the vehicle into the valet mode.

In other embodiments, different codes may be assigned to different users of the vehicle, and the system of the present invention may be made operational to store data regarding specific use of the vehicle. For example, a vehicle which is operated by a number of different persons can store data recording times of use as well as conditions of use (e.g., mileage, speed and the like). Systems of this type may be implemented utilizing the keyless control system described hereinabove wherein smart relays can be employed to process and respond to information. In other instances, the system may be implemented utilizing other control systems.

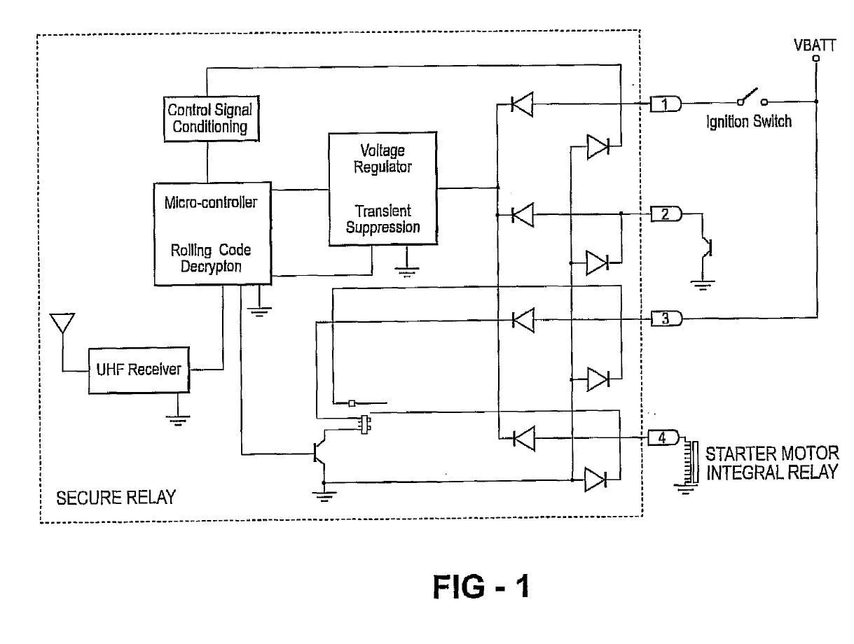

Further details of the control system of tie present invention will be found in Appendix A, which comprises pages A1-A4, of which page A4 contains FIG. 1 of this application, and which forms a portion of this disclosure.

From the foregoing it will be understood that, in accord with the present invention, various keyless control systems may be implemented through the use of the principles of the present invention. The foregoing description and discussion is illustrative of particular embodiments of the invention, but is not meant to be a limitation upon the practice thereof. It is the claims which follow Appendix A, including all equivalents, which define the scope of the invention.

1. A keyless control system for a structure, said system comprising:
an actuator for activating a device associated with said structure;
a control circuit for supplying electrical power to said actuator; and
a smart relay in electrical communication with said control circuit, said smart relay having an electromagnetic signal receiver associated therewith wherein said receiver is operative to activate the relay upon receipt of an appropriate electromagnetic signal.

2. The control system of claim 1, wherein said structure is a motor vehicle, and said activator is operable to control a vehicular function selected from the group consisting of: door locks, door opener, windows, ignition switch, starter, lights, horn, fuel pump, and combinations thereof.

3. The system of claim 2, wherein said system is retrofittable onto a motor vehicle not otherwise having said keyless control system, wherein said smart relay is configured to be a direct replacement for a preexisting control relay in said vehicle.

4. The control system of claim 1, wherein said smart relay further includes a transmitter.

5. The control system of claim 4, wherein said system further includes at least one other smart relay and wherein said transmitter is operable to broadcast a signal to said at least one other smart relay.

6. The control system of claim 4, wherein said transmitter is operative to broadcast to a base station separate from said structure.

7. The control system of claim 1, wherein said smart relay is further activatable by an electrical signal communicated thereto by an electrical circuit.

8. A method of providing keyless control for a function of a motor vehicle wherein said motor vehicle includes a control system of the type comprising:
an activator for activating a device associated with said motor vehicle;
a control circuit for supplying electrical power to said activator; and
a control relay in electrical communication with said control circuit, said relay being activatable by said control circuit, wherein said relay when activated is operable to cause said actuator to activate said control system;
wherein said method comprises the steps of:
providing a smart relay, said smart relay having a signal receiver associated therewith, said smart relay being operable, upon receipt of a control signal from said receiver;
substituting said smart relay for said control relay so that said smart relay, when activated by receipt of said radiofrequency control signal, is operable to cause said actuator to activate said vehicular function; and
providing a radiofrequency transmitter which is operable to provide a radiofrequency control signal to said smart relay for activating said smart relay.

9. A keyless control system for a motor vehicle, said system comprising:
a transmitter operable to provide a signal;
a receiver associated with the motor vehicle, said receiver being operable to provide a vehicular control signal upon receipt of said signal from said transmitter, said control signal being operative to control a function of said vehicle;
wherein said control signal enables the starting circuit of the motor vehicle so that the vehicle may be started by subsequent activation of the starter motor.

10. The control system of claim 9, wherein said activation of said starter motor is a manual activation.

11 The system of claim 9, wherein said control signal enables the operation of the starter motor.

12. The system of claim 9, wherein said control signal enables the operation of the ignition.

13. The control system of claim 9, wherein said receiver, upon receipt of said signal, generates a control signal which allows the vehicle to operate only at a speed which does not exceed a preselected speed limit.

14. The control system of claim 9, wherein said receiver, upon receipt of said signal, generates a control signal which allows said motor vehicle to be driven over a distance which does not exceed a preselected distance.

15. The control system of claim 9, wherein said system stores data corresponding to signals which it has received.
